(19) United States
(12) Patent Application Publication
(10) Pub. No.: US 2024/0142954 A1
(43) Pub. Date: May 2, 2024

(54) COMMUNICATION SYSTEM WITH ORDERED COMMAND DATA SETS

(71) Applicant: KABUSHIKI KAISHA YASKAWA DENKI, Kitakyushu-shi (JP)

(72) Inventors: Yuki MINAMIDA, Fukuoka (JP); Kazuo FUJINO, Fukuoka (JP); Ryota MORIWAKA, Fukuoka (JP); Ryo SHIMODOME, Fukuoka (JP); Tadasuke YUBA, Fukuoka (JP); Kazutoshi KOBAYASHI, Fukuoka (JP)

(21) Appl. No.: 18/396,700

(22) Filed: Dec. 27, 2023

Related U.S. Application Data
(63) Continuation of application No. PCT/JP2022/007885, filed on Feb. 25, 2022.
(60) Provisional application No. 63/218,928, filed on Jul. 7, 2021.

(51) Int. Cl. G05B 19/418

(52) U.S. Cl. CPC G05B 19/4185; G05B 19/41895; G05B 2219/23115

(57) ABSTRACT

A communication system include: a first communication device configured to: add order information to each of the plurality of data sets; and sequentially transmit the plurality of data sets to which the order information is added; and a second communication device configured to: receive the plurality of data sets from the first communication device; arrange the plurality of received data sets in a standby buffer as ordered data sets based on the order information; and sequentially read the ordered data sets.

### CROSS-REFERENCE TO RELATED APPLICATIONS

This application is a continuation application of PCT Application No. PCT/JP2022/007885, filed on Feb. 25, 2022, which claims the benefit of priority from U.S. Provisional Patent Application No. 63/218,928, filed on Jul. 7, 2021. The entire contents of the above listed PCT and priority applications are incorporated herein by reference.

### BACKGROUND

### Field

The present disclosure relates to a communication system, a control system, and a communication method.

### Description of the Related Art

Japanese Unexamined Patent Publication No. 2019-209454 discloses a system including a robot, a machining device, a robot controller that controls the robot, a machining device controller that controls the machining device, and a programmable logic controller that generates commands for the robot controller and the machining device controller.

### SUMMARY

Disclosed herein is a communication system. The communication system may include: a first communication device configured to: add order information to each of the plurality of data sets; and sequentially transmit the plurality of data sets to which the order information is added; and a second communication device configured to: receive the plurality of data sets from the first communication device; arrange the plurality of received data sets in a standby buffer as ordered data sets based on the order information; and sequentially read the ordered data sets.

Additionally, a communication method. is disclosed herein. The communication method. may include: adding order information to each of a plurality of data sets; sequentially transmitting the plurality of data sets to which the order information is added; sequentially receiving the plurality of data sets; arranging the plurality of received data sets in a standby buffer in an order based on the order information; and sequentially reading the plurality of data sets stored in the standby buffer in the order in which the plurality of data sets are arranged.

### BRIEF DESCRIPTION OF THE DRAWINGS

FIG. 1 is a schematic diagram illustrating an example communication system.

FIG. 2 is a schematic diagram illustrating an example configuration of a robot.

FIG. 3 is a block diagram illustrating example functional configurations of a control server and a communication device.

FIG. 4 is a block diagram illustrating an example functional configuration of a communication device and a local device.

FIG. 5 is a schematic diagram illustrating example storage contents of a reception buffer and example storage contents of a standby buffer.

FIG. 6 is a block diagram illustrating a modified example of a communication device and a local device.

FIG. 7 is a block diagram illustrating a modified example of a control server and a communication device.

FIG. 8 is a block diagram illustrating a further modified example of a control server.

FIG. 9 is a block diagram illustrating an example hardware configuration of a control server and a communication device.

FIG. 10 is a block diagram illustrating an example hardware configuration of a communication device and a local device.

FIG. 11 is a flowchart illustrating an example procedure for generating and transmitting a command data set.

FIG. 12 is a flowchart illustrating an example procedure for arranging a plurality of command data sets.

FIG. 13 is a flowchart illustrating an example communication procedure.

FIG. 14 is a flowchart illustrating an example local control procedure.

FIG. 15 is a flowchart illustrating an example procedure for arranging a plurality of feedback data sets.

FIG. 16 is a flowchart illustrating a communication procedure.

### DETAILED DESCRIPTION

In the following description, with reference to the drawings, the same reference numbers are assigned to the same components or to similar components having the same function, and overlapping description is omitted.

Communication System

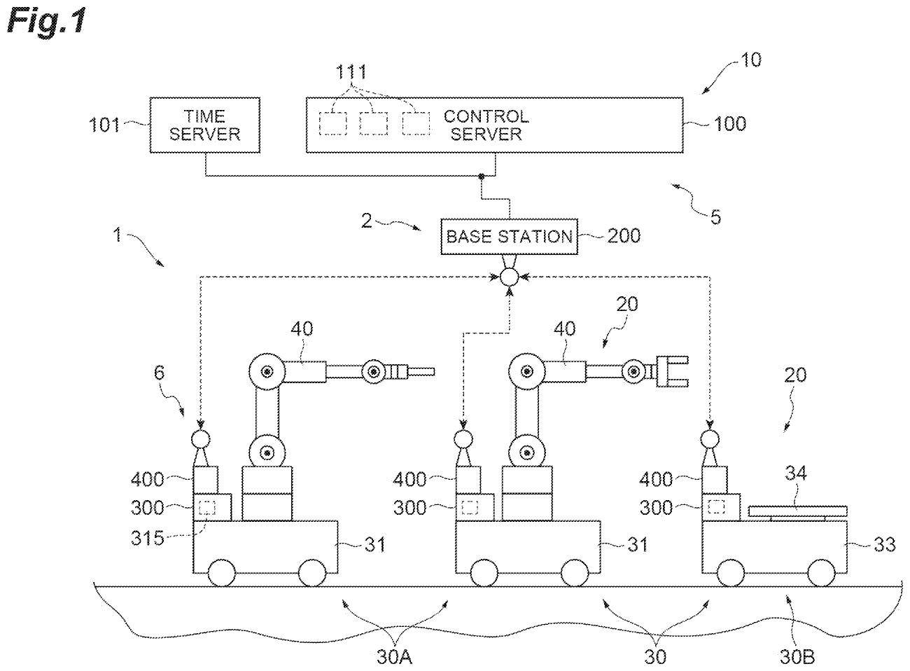

A communication system 1 illustrated in FIG. 1 is a system that performs communication of a plurality of data sets between a supplying application that supplies the plurality of data sets and a using application that uses the supplied plurality of data sets. In communication, the transmission order of a plurality of data sets and the reception order of the plurality of data sets may be changed in some cases. For example, a data set that was transmitted earlier may be received later than a data set that was transmitted later. Such a change occurs irregularly. For this reason, when communication of a plurality of data sets is performed between the supplying application and the using application, there is a possibility that the plurality of data sets are not used in an expected order in the using application.

Thus, the communication system 1 is configured to perform: adding order information to each of a plurality of data sets; sequentially transmitting the plurality of data sets to which the order information is added; sequentially receiving the plurality of data sets that has been transmitted; arranging the data sets that are received in a standby buffer in an order based on the order information; and sequentially reading the plurality of data sets stored in the standby buffer in the order in which the plurality of data sets are arranged.

Even if the transmission order and the reception order are changed, with the communication system 1, a plurality of data sets can be sequentially read in the order based on the order information. Therefore, the order of use of a plurality of data sets can be controlled by the order information regardless of the reception order. Accordingly, a plurality of data sets received by communication may be used in an expected order.

The communication system 1 can be applied to various systems in which communication occurs between a supplying application and a using application. In the following, a case in which the communication system 1 is applied to a control system 10 will be described in detail.

The control system 10 includes the communication system 1, a controller 111 that sequentially generates a plurality of command data sets, and a local controller 315 that operates a machine 30 based on the plurality of command data sets.

The communication system 1 applied to the control system 10 performs: adding order information to each of a plurality of command data sets generated by the controller 111; sequentially transmitting the plurality of command data sets to which the order information is added; sequentially receiving the plurality of command data sets that has been transmitted; arranging the plurality of command data sets that are received in a standby buffer in an order based on the order information; and sequentially reading the plurality of command data sets stored in the standby buffer in the order in which the plurality of data sets are stored. The local controller 315 operates the machine 30 based on the command data sets sequentially read out by the communication system 1. In the communication of the plurality of command data sets, the controller 111 is the supplying application and the local controller 315 is the using application.

The control system 10 may include a plurality of local controllers 315 each operating a plurality of machines 30 and a plurality of controllers 111 each corresponding to the plurality of the local controller 315. The machines 30 are machines that provide motion. Although the type of the machines 30 is not particularly limited, two types of machines 30A, 30B are illustrated in FIG. 1. The machine 30A is a mobile robot that performs operations on a workpiece while moving. For example, the machine 30A includes an automated guided vehicle 31 and a robot 40. The automated guided vehicle 31 moves driven by the local controller 315.

The robot 40 is installed on the automated guided vehicle 31. The robot 40 is driven by the local controller 315 to perform operations such as transport, processing, and assembly on the workpiece.

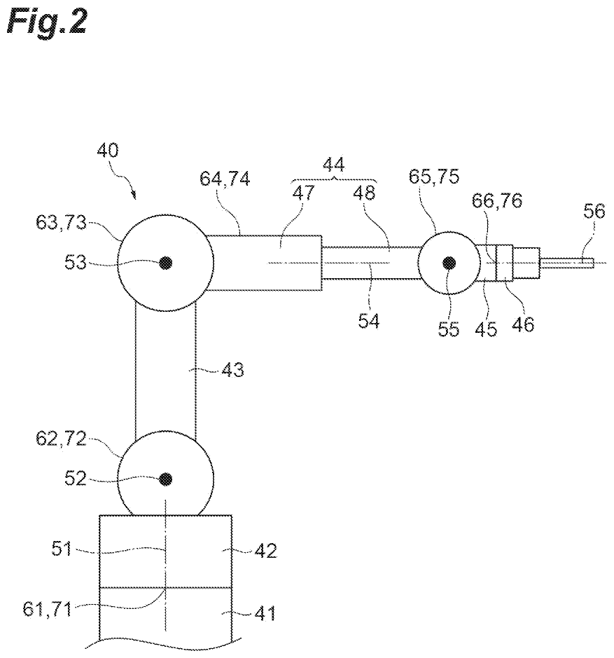

The robot 40 is, for example, a vertical articulated industrial robot. As illustrated in FIG. 2, the robot 40 includes a base 41, a rotating portion 42, a first arm 43, a second arm 44, a wrist portion 45, and a tip portion 46. The base 41 is installed on the automated guided vehicle 31. The rotating portion 42 is mounted on the base 41 so as to be rotatable about a vertical an axis 51. For example, the robot 40 includes a joint 61 that attaches the rotating portion 42 to the base 41 so that it is rotatable about the axis 51. The first arm 43 is connected to the rotating portion 42 so as to be rotatable about an axis 52 that intersects (for example, is orthogonal to) the axis 51. For example, the robot 40 includes a joint 62 that connects the first arm 43 to the rotating portion 42 so as to be rotatable about the axis 52. The intersection includes being in a twisted relationship like so-called three-dimensional intersection. The same applies to the following description. The first arm 43 extends from the rotating portion 42 along a direction that intersects (for example, is orthogonal to) the axis 52.

The second arm 44 is connected to the end of the first arm 43 so as to be rotatable about an axis 53 parallel to the axis 52. For example, the robot 40 includes a joint 63 that connects the second arm 44 to the first arm 43 so as to be rotatable about the axis 53. The second arm 44 includes an arm base 47 extending from an end of the first arm 43 along one direction that intersects (for example, is orthogonal to) the axis 53 and an arm end 48 further extending from an end of the arm base 47 along the same direction. The arm end 48 is rotatable about an axis 54 relative to the arm base 47. The axis 54 intersects (for example, is orthogonal to) the axis 53. For example, the robot 40 includes a joint 64 that connects the arm end 48 to the arm base 47 so as to be rotatable about the axis 54.

The wrist portion 45 is connected to the end of the arm end 48 so as to be rotatable about an axis 55 that intersects (for example, is orthogonal to) the axis 54. For example, the robot 40 includes a joint 65 that connects the wrist portion 45 to the arm end 48 so as to be rotatable about the axis 55. The wrist portion 45 extends from an end of the arm end 48 along a direction that intersects (for example, is orthogonal to) the axis 55. The tip portion 46 is connected to the end of the wrist portion 45 so as to be rotatable about an axis 56 that intersects (for example, is orthogonal to) the axis 55. For example, the robot 40 includes a joint 66 that connects the tip portion 46 to the wrist portion 45 so as to be rotatable about the axis 56. The tip portion 46 is provided with an end effector. Examples of the end effector include a hand that grips a workpiece and a work tool that performs processing, assembly, and the like on a workpiece.

Actuators 71, 72, 73, 74, 75, 76, drive the joints 61, 62, 63, 64, 65, 66. Each of the actuators 71, 72, 73, 74, 75, 76 includes, for example, an electric motor and a transmission unit (for example, a speed reducer) that transmits power of the electric motor to the joints 61, 62, 63, 64, 65, 66. For example, the actuator 71 drives the joint 61 to rotate the rotating portion 42 about the axis 51. The actuator 72 drives the joint 62 to rotate the first arm 43 about the axis 52. The actuator 73 drives the joint 63 to rotate the second arm 44 about the axis 53. The actuator 74 drives the joint 64 to rotate the arm end 48 about the axis 54. The actuator 75 drives the joint 65 to rotate the wrist portion 45 about the axis 55. The actuator 76 drives the joint 66 to rotate the tip portion 46 about the axis 56.

Returning to FIG. 1, a machine 30B is an automated guided vehicle that conveys a conveyance object such as a workpiece. The machine 30B includes an automated guided vehicle 33 and a loading table 34. The automated guided vehicle 33 moves driven by the local controller 315. The loading table 34 is installed on the automated guided vehicle 33 and supports the conveyance object.

Hereinafter, the configuration of the control system 10 will be described in more detail. As illustrated in FIG. 1, the control system 10 includes a control server 100, a time server 101, a local device 300, a communication device 200, and a communication device 400. The control server 100 includes the controller 111 for controlling the machine 30. The local device 300 includes the local controller 315 for operating the machine 30.

The communication device 200 and the communication device 400 perform communication between the control server 100 and the local device 300. The communication device 200 and the communication device 400 may be configured to perform network communication. “Network communication” represents communication performed via a mesh-like communication line. In the mesh-like communication line, the arrival time of the data set from the communication device 200 to the communication device 400 changes depending on which path is taken. This may contribute to the change of transmission order and reception order described above.

The communication device 200 and the communication device 400 may be configured to perform wireless communication. In wireless communication, communication delay may be different for each data set due to packet loss or the like. This may contribute to the change between the transmission order and the reception order described above. The communication device 200 and the communication device 400 may be configured to perform wireless network communication including wireless communication in at least a part of the mesh-like communication line. The communication device 200 and the communication device 400 may be configured to perform wired communication.

The communication device 200 and the communication device 400 may be configured to perform mobile communication. For example, the communication device 200 may be a base station for mobile communication and the communication device 400 may be a mobile station for mobile communication. The communication device 200 and the communication device 400 may be configured to perform communication via a fifth-generation mobile communication system (5G communication).

The communication device 200 is in wired connection with the control server 100. The communication device 200 transmits a plurality of command data sets acquired from the controller 111 to a corresponding communication device 400.

The communication device 400 is in wired connection with the local device 300. The local device 300 acquires a plurality of command data sets that the communication device 400 receives from the communication device 200.

The communication device 200 and the communication device 400 form part of the communication system 1. Furthermore, the control server 100 and the local device 300 also form part of the communication system 1. For example, the control server 100 is configured to add the order information to each of a plurality of command data sets acquired by the communication device 200 from the controller 111. The local device 300 is configured to perform: arranging the plurality of command data sets acquired from the communication device 400 in the standby buffer in an order based on the order information; and sequentially reading the plurality of command data sets stored in the standby buffer in the order in which the plurality of command data sets are stored. The local controller 315 operates the machine 30 based on the command data sets sequentially read out by the local device 300.

The time server 101 is in wired connection with the control server 100 and generates global time. As described later, the global time is used for matching at least the time inside the control server 100 and the time inside the local device 300. The time server 101 may be incorporated into the control server 100 or may be incorporated into the communication device 200.

If the control system 10 includes a plurality of machines 30, the control system 10 may include a plurality of local devices 300 respectively corresponding to the plurality of machines 30 and a plurality of communication devices 400 respectively corresponding to the plurality of machines 30. The control server 100 may include a plurality of controllers 111 respectively corresponding to the plurality of machines 30.

Each of the plurality of local devices 300 includes the local controller 315 that operates a corresponding machine 30. Each of the plurality of local devices 300 is provided in the corresponding machine 30. For example, the local device 300 corresponding to the machine 30A is provided on the automated guided vehicle 31 of the machine 30A, and the local device 300 corresponding to the machine 30B is provided on the automated guided vehicle 33 of the machine 30B.

The communication device 200 transmits a plurality of command data sets acquired from each of the plurality of the controller 111 to the corresponding communication device 400. Each of the plurality of communication devices 400 causes the corresponding local device 300 to acquire the command data sets received from the communication device 200.

Each of the plurality of communication devices 400 is provided in a corresponding machine 30. For example, the communication device 400 corresponding to the machine 30A is provided on the automated guided vehicle 31 of the machine 30A. The communication device 400 corresponding to the machine 30B is provided on the automated guided vehicle 33 of the machine 30B.

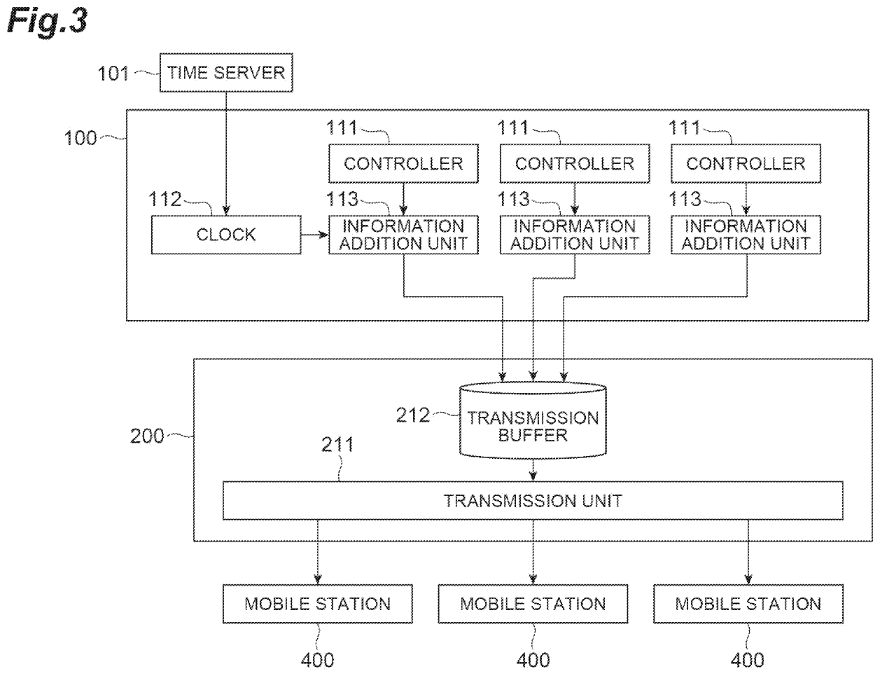

FIG. 3 is a block diagram illustrating an example functional configuration of the control server 100 and the communication device 200.

As illustrated in FIG. 3, the control server 100 includes the plurality of controllers 111 that are above-described, a clock 112, and an information addition unit 113 as functional components (hereinafter referred to as “functional blocks”). Each of the plurality of controllers 111 sequentially generates a plurality of command data sets for controlling the corresponding machine 30.

Each of the controllers 111 may repeat generation of a command data set for controlling a corresponding machine 30 at a predetermined control cycle. For example, each of the controller 111 executes control processing including generation of a command data set every time a periodic control clock signal is generated.

The command data set is, for example, a data set representing an operation command for the machine 30. The command data set may be a data set representing a target motion of the machine 30. The target motion includes a target position, a target speed, or the like of the machine 30.

The clock 112 repeatedly generates time at a constant cycle. Hereinafter, the time which the clock 112 generates is referred to as “server time”. The clock 112 may be configured to generate a server time that is synchronized to the global time. For example, the clock 112 receives the global time from the time server 101 via communication that guarantees time synchronization, such as time sensitive networking (TSN) communication via a wired communication network, and generates the server time in synchronization with the received global time. For example, the clock 112 synchronizes the server time with the global time and then repeatedly updates the server time by counting clock pulses of a certain cycle. The clock 112 may repeatedly perform synchronization of the server time with the global time at predetermined time intervals.

The information addition unit 113 adds the order information to each of a plurality of command data sets. For example, every time the controller 111 generates a command data set, the information addition unit 113 adds order information to the command data set and sends the command data set to the communication device 200. For example, the information addition unit 113 stores a command data set to which order information is added in a transmission buffer 212 of the communication device 200.

The order information is information for defining an arrangement order of a plurality of command data sets. For example, order information has a value, and the position (order) of each command data set in the arrangement order is defined based on comparison with the values of other order information. The information addition unit 113 adds order information whose value increases toward the end of the arrangement order to each of the plurality of command data sets so that the plurality of command data sets are arranged in a predetermined arrangement order. For example, the information addition unit 113 may add order information including a count value from the head in the arrangement order to each of the plurality of command data sets.

The information addition unit 113 may add order information whose value decreases toward the end of the arrangement order to each of the plurality of command data sets. For example, the information addition unit 113 may add order information including a count value from the tail in the arrangement order to each of the plurality of command data sets.

The information addition unit 113 may add order information to each of the plurality of command data sets such that the order of the plurality of command data sets is the order of generation by the controller 111. For example, the information addition unit 113 adds, to each of a plurality of command data sets, order information whose value increases as the order of generation by the controller 111 comes later.

For example, every time the controller 111 generates a command data set, the information addition unit 113 adds order information including server time at the time of generation to each of the plurality of command data sets. Hereinafter, the server time at the time of generation is referred to as a “generation time”. The information addition unit 113 may add order information including server time immediately before order information is added to each of the plurality of command data sets. Hereinafter, server time immediately before order information is added is referred to as an “addition time”.

The information addition unit 113 may add a count value, which is counted up every time the controller 111 generates the command data set, to the command data set as order information.

The information addition unit 113 may add order information including timing information defining read timing of the command data set by the local device 300 to each of the plurality of command data sets. The timing information may be information directly specifying read timing of the command data set by the local device 300. For example, the information addition unit 113 calculates a read time indicating read timing by adding a predetermined delay time to the generation time or the addition time and adds order information including the calculated read time to each of the plurality of command data sets.

The timing information may be information indirectly specifying a timing at which the local device 300 should read the command data set. For example, the timing information may be information indicating reference timing before transmission timing of a command data set by the communication device 200 (a transmission unit 211 described below). If the delay time from the reference timing to the read timing is constant, the read timing is indirectly defined by the generation time or the addition time. Examples of the information indicating the reference timing include the generation time or the addition time.

If the control server 100 includes a plurality of controllers 111, the control server 100 may have a plurality of information addition units 113, each corresponding to a plurality of controllers 111. Each of the plurality of information addition units 113 adds the controller 111 identification information and order information to the command data set every time the corresponding controller 111 generates the command data set, and transmits the command data set to the communication device 200. Based on the identification information of the controller 111, the command data set generated by the controller 111 can be transmitted to the communication device 400 corresponding to the controller 111.

The communication device 200 includes the transmission unit 211 and the transmission buffer 212 as functional blocks. The transmission buffer 212 is a storage unit for temporarily storing a plurality of command data sets sent from the information addition unit 113 with order information added thereto. The transmission unit 211 sequentially reads a plurality of command data sets to which order information is added from the transmission buffer 212.

The transmission unit 211 may read a plurality of command data sets from the transmission buffer 212 in a first in first out (FIFO) manner. For example, the transmission unit 211 sequentially reads a plurality of command data sets stored in the transmission buffer 212 from the transmission buffer 212 in the order in which they are stored.

Here, “read” includes excluding the data set read from the read destination such as the transmission buffer 212 from the next and subsequent read targets. Examples of excluding the read data set from the next and subsequent read targets include deleting the read data set from the read destination. Instead of deleting the read data set from the next and subsequent read targets, a read completion flag may be attached to the read data set, and the data set to which the read completion flag is attached may be excluded from the next and subsequent read targets. The same applies to a case where data set is read from read destinations other than the transmission buffer 212.

The transmission unit 211 transmits the command data set read from the transmission buffer 212 to the communication device 400. The transmission unit 211 may transmit the command data set via network communication, may transmit the command data set via wireless communication, or may transmit the command data set via mobile communication.

When the control server 100 includes a plurality of controllers 111, the transmission unit 211 transmits the command data set to the communication device 400 corresponding to the controller 111 based on the identification information of the controller 111 added to the command data set read from the transmission buffer 212. Thus, the plurality of command data sets generated by the corresponding controller 111 are sequentially transmitted to each of the plurality of communication devices 400.

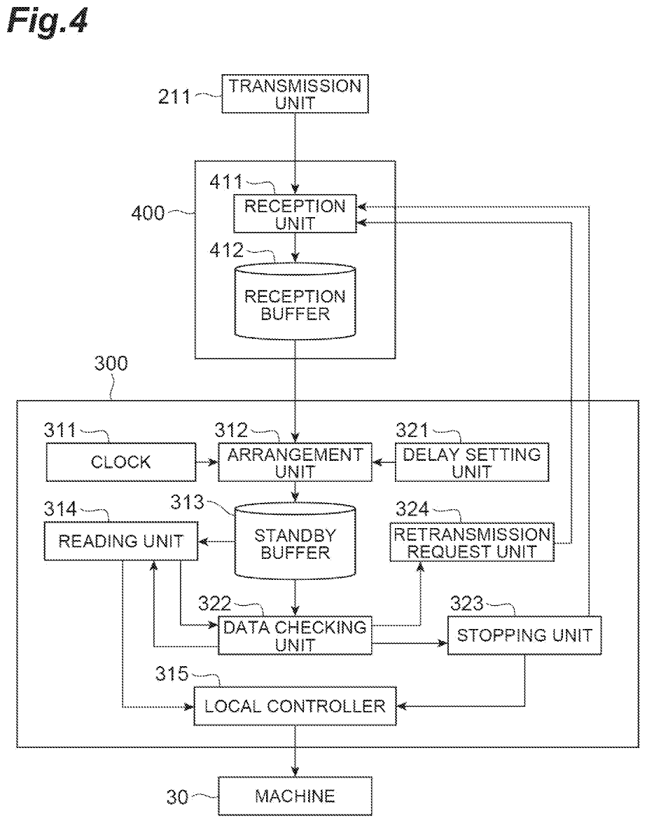

FIG. 4 is a block diagram illustrating a functional configuration of the local device 300 and the communication device 400. As illustrated in FIG. 4, the communication device 400 includes a reception unit 411 and a reception buffer 412 as functional blocks. The reception unit 411 sequentially receives a plurality of command data sets from the transmission unit 211. The reception unit 411 may receive a command data set from the transmission unit 211 via network communication, may receive a command data set from the transmission unit 211 via wireless communication, or may receive a command data set from the transmission unit 211 via mobile communication.

The reception unit 411 stores a plurality of command data sets in the reception buffer 412 in the order in which they are received. In some cases, the order in which the reception unit 411 receives the plurality of command data sets is different from the order in which the transmission unit 211 transmitted the plurality of command data sets.

The local device 300 includes a clock 311, an arrangement unit 312, a standby buffer 313, a reading unit 314, and the local controller 315 as functional blocks. The clock 311 repeatedly generates time in a constant cycle. Hereinafter, the time at which the clock 311 is generated is referred to as a “local time”. The clock 311 may be configured to generate a local time synchronized to the global time. For example, the clock 311 receives the server time from the control server 100 by communication that guarantees time synchronization, such as TSN communication, and generates the local time in synchronization with the received server time. For example, the clock 311 synchronizes the local time with the server time and then repeatedly updates the local time by counting clock pulses of a certain cycle. The clock 311 may repeatedly perform synchronization of the local time to the server time at predetermined time intervals.

The standby buffer 313 is a storage unit for temporarily storing a plurality of command data sets in an order based on the order information. The arrangement unit 312 arranges the plurality of command data sets received by the reception unit 411 in the standby buffer 313 in an order based on the order information. For example, the arrangement unit 312 reads a plurality of command data sets from the reception buffer 412 in a FIFO manner. For example, the arrangement unit 312 reads a plurality of command data sets stored in the reception buffer 412 from the reception buffer 412 in the order in which they are stored.

The arrangement unit 312 arranges a plurality of command data sets read from the reception buffer 412 in the standby buffer 313 in an order based on the order information. For example, the arrangement unit 312 arranges them in the standby buffer 313 in the above-described predetermined arrangement order based on order information. For example, in a case where order information whose value increases toward the end of the arrangement order is added to each of the plurality of command data sets, the arrangement unit 312 arranges the plurality of command data sets in the standby buffer 313 such that the command data sets are arranged in ascending order of the value of the order information. In a case where order information whose value decreases toward the end of the arrangement order is added to each of the plurality of command data sets, the arrangement unit 312 arranges the plurality of command data sets in the standby buffer 313 such that the command data sets are arranged in descending order of the value of the order information.

If the order information including the timing information is added to each of the plurality of command data sets, the arrangement unit 312 may arrange the plurality of command data sets in the standby buffer 313 in the order of read timing based on the timing information.

For example, if the order information including the read time is added to each of a plurality of command data sets, the arrangement unit 312 may arrange the plurality of command data sets in the standby buffer 313 such that the command data sets are arranged in the order of the read time. When the order information including the generation time is added to each of the plurality of command data sets, the arrangement unit 312 may arrange the plurality of command data sets in the standby buffer 313 such that the command data sets are arranged in order of the generation time. When the order information including the addition time is added to each of the plurality of command data sets, the arrangement unit 312 may arrange the plurality of command data sets in the standby buffer 313 such that the command data sets are arranged in the order of the addition time.

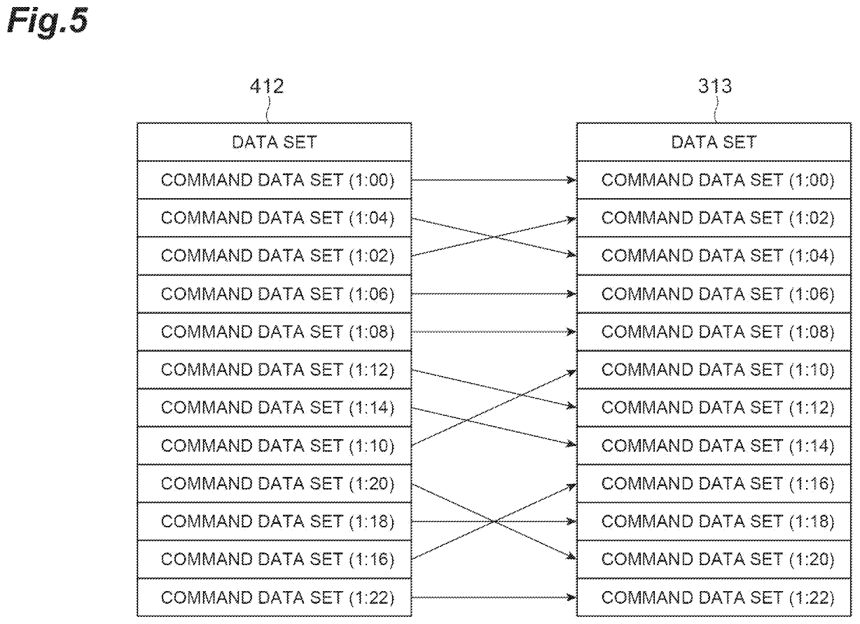

FIG. 5 is a diagram schematically illustrating stored contents of the reception buffer 412 and stored contents of the standby buffer 313. A numerical value shown in parentheses of each command data set represents a generation time. As described above, transmission of a plurality of command data sets by the transmission unit 211 is performed in the order of generation time. However, since the transmission order of the plurality of command data sets and the reception order of the plurality of command data sets may be changed, the arrangement of the plurality of command data sets in the reception buffer 412 may not be the order of generation time. As illustrated in FIG. 5, a plurality of command data sets that are not arranged in the order of generation time in the reception buffer 412 are rearranged in the order of generation time in the standby buffer 313 by the arrangement unit 312.

Referring back to FIG. 4, the reading unit 314 sequentially reads a plurality of command data sets stored in the standby buffer 313 in the order in which the plurality of command data sets are arranged. The reading unit 314 may repeat reading the command data set from the standby buffer 313 at a constant read cycle. For example, every time a periodic read clock signal is generated, the reading unit 314 reads the head data set positioned at the head of the array in the standby buffer 313 among the plurality of command data sets.

The reading unit 314 may read each of the plurality of command data sets at read timing specified by the timing information. For example, the reading unit 314 may read the head data set when the read time specified by the timing information of the head data set is included in the executing period of the read cycle. Hereinafter, the head data set in which the read time specified by the timing information is included in the execution period of the read cycle is referred to as a “read target data set”.

When the cycle length of the read cycle and the cycle length of the control cycle coincide with each other, one read target data set exists every read cycle unless the command data set is missed, so that the reading of the command data set from the standby buffer 313 is repeated at the read cycle.

The reading unit 314 may read each of the plurality of command data sets at a read timing at which a predetermined delay time has elapsed from the reference timing. When storing each of the plurality of command data sets in the standby buffer 313, the arrangement unit 312 may convert the reference timing included in the timing information into the read timing. For example, the arrangement unit 312 may calculate the read time by adding the delay time to the generation time or the addition time of the timing information and include the calculated read time in the timing information. The reading unit 314 reads the head data set when the read time included in the order information by the arrangement unit 312 is included in the executing period of the read cycle.

The arrangement unit 312 may convert the read time specified by the timing information into the number of read cycles from the storage time in the standby buffer 313 (time at which the command data set is stored in the standby buffer 313) to the read time. For example, the arrangement unit 312 may calculate the number of standby cycles by dividing the time from the storage time to the read time in the standby buffer 313 by the read cycle, and include the calculated number of standby cycles in the timing information.

The reading unit 314 repeatedly counts down the number of standby cycles of each of the plurality of command data sets arranged in the standby buffer 313 at a read cycle, and reads the head data set in which the number of standby cycles is zero from the standby buffer 313. The number of standby cycles being zero means that the read time is included in the execution period of the read cycle. Therefore, the head data set whose number of standby cycles is zero is the read target data set.

The local controller 315 operates the corresponding machine 30 based on the plurality of command data sets read by the reading unit 314. For example, each time the reading unit 314 reads the command data set, the local controller 315 causes the machine 30 to execute an operation corresponding to the target operation represented by the command data set. Thus, the control of the machine 30 is repeated at the local control cycle having the same cycle length as the read cycle. If the target motion includes the target position, the local controller 315 repeats causing the machine 30 to follow the target position in the local control cycle. If the target motion includes the target speed, the local controller 315 repeats causing the motion speed of the machine 30 to follow the target speed in the local control cycle.

The local device 300 may further include a delay setting unit 321. The delay setting unit 321 sets a delay time for converting the reference timing into the read timing based on an input to a user interface.

The local device 300 may further include a data checking unit 322, a stopping unit 323, and a retransmission request unit 324. The data checking unit 322 detects missing of a command data set to be read in the read cycle based on an arrangement of a plurality of command data sets in the standby buffer 313 and timing information.

For example, when the timing information of the head data set does not correspond to the read cycle for reading the head data set, the data checking unit 322 detects the missing of the command data set to be read before the head data set. For example, when the read time specified by the timing information of the head data set is not included in the executing period of the read cycle for reading the head data set, the data checking unit 322 detects the missing of the command data set to be read before the head data set.

Hereinafter, a read cycle in which the head data set is read is referred to as a “head read cycle”. Missing of the command data set to be read before the head data set is referred to as “missing of read target data set”. As described above, when the cycle length of the read cycle matches the cycle length of the control cycle, one read target data set exists for each read cycle unless missing of the command data set occurs. Therefore, each read cycle is a “head read cycle”. The data checking unit 322 may detect a missing of read target data set when the number of standby cycles of the head data set is not zero.

The data checking unit 322 may check whether the timing information of the head data set corresponds to the head read cycle after the head read cycle is started or before the head read cycle is started.

The reading unit 314 may wait to read the head data set until the next read cycle of the head read cycle if a missing of read target data set is detected.

The data checking unit 322 may detect, when the difference between the read times is twice or more the read cycle between the two command data sets adjacent to each other in the arrangement in the standby buffer 313, the missing of the command data set to be arranged between the two command data sets. Hereinafter, the missing of the command data set to be disposed between two command data sets is referred to as an “absence of command data set”.

The stopping unit 323 stops the drive unit (for example, the actuators 71, 72, 73, 74, 75, 76, the automated guided vehicle 31, the automated guided vehicle 33, and the like of the machine 30) when the number of read cycles in which missing of the command data set is consecutively detected reaches a predetermined number for drive stoppages. The stopping unit 323 may stop the communication between the transmission unit 211 and the reception unit 411 when the number of read cycles in which missing of the command data set is consecutively detected reaches a predetermined number for communication stoppages, the predetermined number for communication stoppages being greater than the number for drive stoppages. For example, the stopping unit 323 may stop the drive unit when the number of head read cycles in which the missing of read target data set is consecutively detected reaches the number for drive stoppages. The stopping unit 323 may stop communication between the transmission unit 211 and the reception unit 411 when the number of head read cycles in which the missing of read target data set is consecutively detected reaches the number for communication stoppages. The stopping unit 323 may stop the drive unit when the number of times of detection of absences of command data set between two command data sets reaches the number for drive stoppages. The stopping unit 323 may stop communication between the transmission unit 211 and the reception unit 411 when the number of times of detection of absences of command data set between two command data sets reaches the number for communication stoppages.

When the missing of the command data set is detected by the data checking unit 322, the retransmission request unit 324 requests the transmission unit 211 to retransmit the command data set that is detected to be missing. For example, when an absence of command data set is detected due to the data checking unit 322, the retransmission request unit 324 may request the transmission unit 211 to retransmit the command data set that is detected to be absent. The retransmission request unit 324 may request the transmission unit 211 to retransmit the read target data set if missing of read target data set is detected.

The retransmission request unit 324 may cause the reception unit 411 to request the transmission unit 211 to retransmit the command data set. The transmission unit 211 may be configured to hold the transmitted command data set in preparation for a request for retransmission from the retransmission request unit 324. The arrangement unit 312 may cause the reception unit 411 to transmit an acknowledge signal of the command data set to the transmission unit 211 when the command data set is stored in the standby buffer 313. The transmission unit 211 may hold the command data set until an acknowledge signal is received.

The local controller 315 may be configured to sequentially obtain from the machine 30 a plurality of feedback data sets including an operation result based on the plurality of command data sets. The local controller 315 may repeatedly acquire the feedback data sets at the local control cycle. For example, the local controller 315 may acquire the feedback data sets every time the machine 30 is operated based on the command data set in the local control cycle.

The controller 111 may be configured to generate the command data set based on the feedback data set acquired by the local controller 315. For example, the controller 111 may generate a command data set indicating a target output (for example, a target torque or a target current) for causing the motion of the machine 30 indicated by the feedback data set to follow the target motion. For example, the controller 111 may generate the command data set representing the target output by performing a proportional operation, a proportional-integral operation, or a proportional-integral-derivative operation on the deviation between the target motion and the motion of the machine 30 represented by the feedback data set.

The communication system 1 may be configured to perform: adding second order information to each of the plurality of feedback data sets acquired by the local controller 315; sequentially transmitting a plurality of feedback data sets to which second order information is added; receiving a plurality of transmitted feedback data sets sequentially; arranging the received feedback data sets in the second standby buffer in an order based on the second order information; and sequentially reading a plurality of feedback data sets stored in the second standby buffer in the order in which the plurality of feedback data sets are arranged. In the communication of a plurality of feedback data sets, the local controller 315 is the supplying application and the controller 111 is the using application.

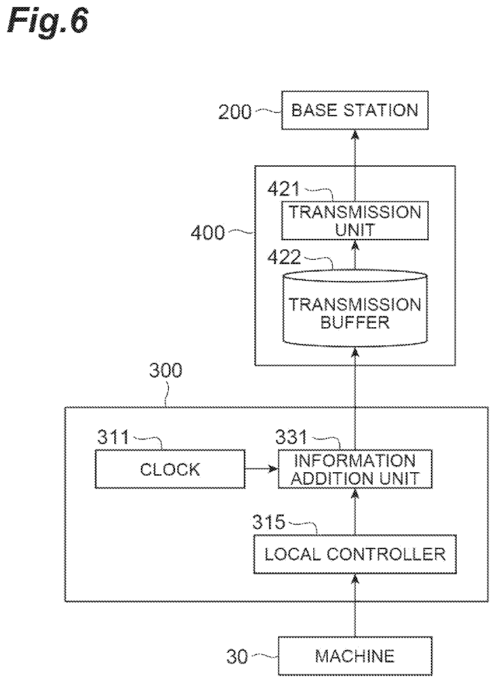

For example, as illustrated in FIG. 6, the local device 300 may further include a second information addition unit 331. The second information addition unit 331 adds second order information to each of the plurality of feedback data sets acquired by the local controller 315. For example, every time the local controller 315 acquires a feedback data set, the second information addition unit 331 adds second order information to the feedback data set and transmits the feedback data set to the communication device 400. For example, the second information addition unit 331 stores feedback data set to which second order information is added in a second transmission buffer 422 of the communication device 400.

The second order information is information for defining an arrangement order of the plurality of feedback data sets. For example, the second order information has a value, and the position (order) of each feedback data set in the arrangement order is defined based on comparison with the value of another second order information. The second information addition unit 331 adds second order information whose value increases toward the end of the arrangement order to each of the plurality of feedback data sets so that the plurality of feedback data sets are arranged in a predetermined arrangement order. For example, the second information addition unit 331 may add second order information including a count value from the head in the arrangement order to each of the plurality of feedback data sets.

The second information addition unit 331 may add second order information whose value decreases toward the end of the arrangement order to each of the plurality of feedback data sets. For example, the second information addition unit 331 may add second order information including a count value from the tail in the arrangement order to each of the plurality of feedback data sets.

The second information addition unit 331 may add second order information to each of the plurality of feedback data sets so that the order of arrangement of the plurality of feedback data sets becomes the order of acquisition by the local controller 315. For example, the second information addition unit 331 adds second order information whose value becomes larger as the acquisition order by the local controller 315 comes later to each of the plurality of feedback data sets.

For example, every time the local controller 315 acquires a feedback data set, the second information addition unit 331 adds order information including a local time at the time of acquisition to each of the plurality of feedback data sets. Hereinafter, local time at the time of acquisition is referred to as an “acquisition time”. The second information addition unit 331 may add second order information including a local time immediately before adding the second order information to each of the plurality of feedback data sets. Hereinafter, the local time immediately before adding the second order information is referred to as a “second addition time”.

The second information addition unit 331 may add a count value, which is counted up every time the local controller 315 acquires the feedback data set, to the feedback data set as the second order information.

The second information addition unit 331 may add second order information including second timing information defining read timing of the feedback data set according to the control server 100 to each of the plurality of feedback data sets. The second timing information may be time information directly specifying read timing of the feedback data set (hereinafter referred to as a “second read timing”) by the control server 100. For example, the second information addition unit 331 calculates a second read time indicating a second read timing by adding a predetermined second delay time to the acquisition time or the second addition time, and adds second order information including the calculated second read time to each of the plurality of feedback data sets.

The second timing information may be time information indirectly specifying a timing at which the control server 100 should read the feedback data set. For example, the second timing information may be information indicating a second reference timing before a transmission timing of a feedback data set by the communication device 400 (a second transmission unit 421 described below). If the second delay time from the second reference timing to the second read timing is constant, the second read timing is indirectly defined by the acquisition time or the second addition time. Examples of the information indicating the second reference timing include the acquisition time or the second addition time.

When the communication system 1 includes a plurality of the machine 30, the second information addition unit 331 adds identification information of corresponding machine 30 and second order information and sends them to the communication device 400. Based on the identification information of the machine 30, the feedback data set can be acquired by the controller 111 corresponding to the machine 30.

The communication device 400 may further include the second transmission unit 421 and the second transmission buffer 422. The second transmission buffer 422 is a storage unit for temporarily storing a plurality of feedback data sets added with second order information and transmitted from the second information addition unit 331. The second transmission unit 421 sequentially reads, from the second transmission buffer 422, a plurality of feedback data sets to which second order information is added.

The second transmission unit 421 may read a plurality of feedback data sets from the second transmission buffer 422 in a FIFO manner. For example, the second transmission unit 421 sequentially reads a plurality of feedback data sets stored in the second transmission buffer 422 from the second transmission buffer 422 in the order in which they are stored.

The second transmission unit 421 transmits the feedback data set read from the second transmission buffer 422 to the communication device 200. The second transmission unit 421 may transmit the feedback data set via network communication, may transmit the feedback data set via wireless communication, and may transmit the feedback data set via mobile communication.

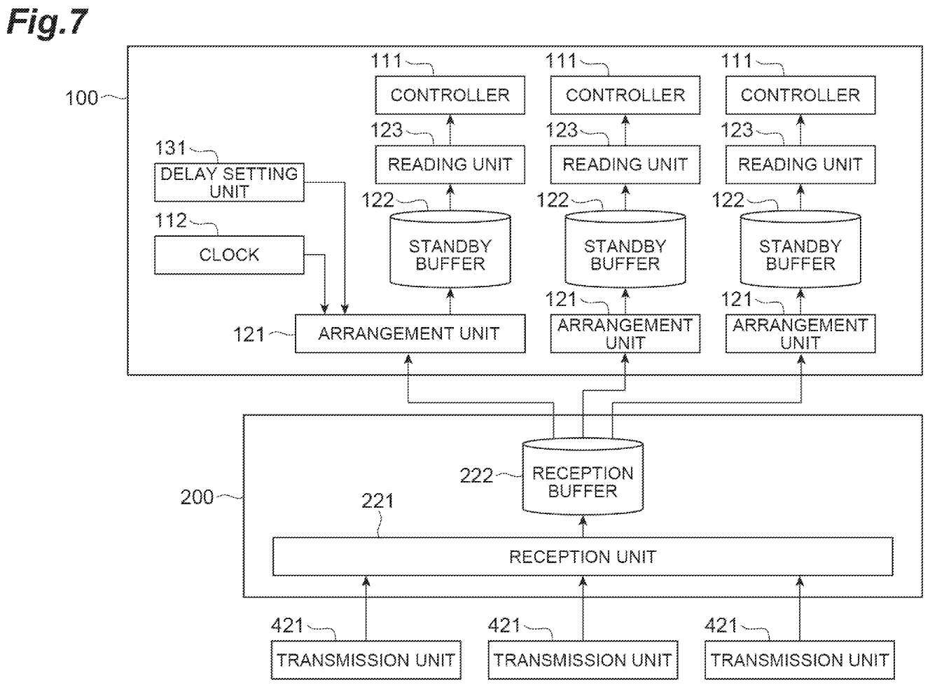

As illustrated in FIG. 7, the communication device 200 further includes a second receiving unit 221 and a second reception buffer 222. The second receiving unit 221 sequentially receives a plurality of feedback data sets from the second transmission unit 421. The second receiving unit 221 may receive a feedback data set from the second transmission unit 421 via network communication, may receive a feedback data set from the second transmission unit 421 via wireless communication, and may receive a feedback data set from the second transmission unit 421 via mobile communication.

The second receiving unit 221 stores a plurality of feedback data sets in the second reception buffer 222 in the order in which the feedback data sets are received. The order in which the second receiving unit 221 receives the plurality of feedback data sets may be different from the order in which the second transmission unit 421 transmitted the plurality of feedback data sets.

If the communication system 1 includes a plurality of machines 30, the second receiving unit 221 may add identification information of the local controller 315 from which the feedback data set is acquired to the feedback data set and store the feedback data set in the second reception buffer 222. Accordingly, a plurality of feedback data sets acquired by the corresponding local controller 315 for each of the plurality of controllers 111 may be acquired.

The control server 100 further includes a second arrangement unit 121, a second standby buffer 122, and a second reading unit 123. The second standby buffer 122 is a storage unit for temporarily storing a plurality of feedback data sets in an order based on second order information. The second arrangement unit 121 arranges the plurality of feedback data sets received by the second receiving unit 221 in the second standby buffer 122 in an order based on the second order information. For example, the second arrangement unit 121 reads a plurality of feedback data sets from the second reception buffer 222 in a FIFO manner. For example, the second arrangement unit 121 reads a plurality of feedback data sets stored in the second reception buffer 222 from the second reception buffer 222 in the order in which they are stored.

The second arrangement unit 121 arranges a plurality of feedback data sets read from the second reception buffer 222 in the second standby buffer 122 in an order based on the second order information. For example, the second arrangement unit 121 arranges the plurality of feedback data sets in the second standby buffer 122 in the above-described predetermined arrangement order based on the second order information. For example, when second order information whose value increases toward the end of the arrangement order is added to each of the plurality of feedback data sets, the second arrangement unit 121 arranges the plurality of feedback data sets in the second standby buffer 122 such that the feedback data sets are arranged in ascending order of the value of the second order information. When second order information whose value decreases toward the end of the arrangement order is added to each of the plurality of feedback data sets, the second arrangement unit 121 arranges the plurality of feedback data sets in the second standby buffer 122 such that the feedback data sets are arranged in descending order of the value of the second order information.

When the second order information including the second timing information is added to each of the plurality of feedback data sets, the second arrangement unit 121 may arrange the plurality of feedback data sets in the second standby buffer 122 in the order of the second read timing based on the second timing information.

For example, when second order information including the second read time is added to each of the plurality of feedback data sets, the second arrangement unit 121 may arrange the plurality of feedback data sets in the second standby buffer 122 so that the feedback data sets are arranged in the order of the second read time. If the second order information including the acquisition time is added to each of the plurality of feedback data sets, the second arrangement unit 121 may arrange the plurality of feedback data sets in the second standby buffer 122 such that the feedback data sets are arranged in order of the acquisition time. If the second order information including the second addition time is added to each of the plurality of feedback data sets, the second arrangement unit 121 may arrange the plurality of feedback data sets in the second standby buffer 122 such that the feedback data sets are arranged in the order of the second addition time.

The second reading unit 123 sequentially reads a plurality of feedback data sets stored in the second standby buffer 122 in the order in which the plurality of feedback data sets are arranged. The second reading unit 123 may repeat reading the command data set from the second standby buffer 122 at a constant second read cycle. For example, every time the periodic second read clock signal is generated, the second reading unit 123 reads the head data set positioned at the head of the array in the second standby buffer 122 from among the plurality of feedback data sets. The second reading unit 123 excludes the read head data set from the array in the second standby buffer 122.

The second reading unit 123 may read each of the plurality of feedback data sets at a second read timing specified by the second timing information. For example, the second reading unit 123 may read the head data set when the second read time specified by the second timing information of the feedback data set is included in the executing period of the second read cycle. Hereinafter, a head data set whose second read time specified by the second timing information is included in the execution period of the second read cycle is referred to as a “read target data set”.

If the cycle length of the second read cycle matches the cycle length of the local control cycle, one read target data set is present in every second read cycle unless the feedback data set is missed. Therefore, reading of the feedback data set from the second standby buffer 122 is repeated at the second read cycle.

The second reading unit 123 may read each of the plurality of feedback data sets at a second read timing at which a predetermined second delay time elapses from the second reference timing. When storing each of the plurality of feedback data sets in the second standby buffer 122, the second arrangement unit 121 may convert the second reference timing included in the second timing information into the second read timing. For example, the second arrangement unit 121 may calculate the second read time by adding the second delay time to the acquisition time or the second addition time of the second timing information and include the calculated second read time in the second timing information. The second reading unit 123 reads the head data set when the second read time included in the second order information by the second arrangement unit 121 is included in the executing period of the second read cycle.

The second arrangement unit 121 may convert the second read time specified by the second timing information into the number of second read cycles from the storage time in the second standby buffer 122 (time at which the feedback data set is stored in the second standby buffer 122) to the second read time. For example, the second arrangement unit 121 may calculate the number of second standby cycles by dividing the time from the storage time in the second standby buffer 122 to the second read time by the second read cycle, and include the calculated number of second standby cycles in the second timing information.

The second reading unit 123 repeatedly counts down the number of second standby cycles of each of the plurality of feedback data sets arranged in the second standby buffer 122 by the second read cycle, and reads out the head data set in which the number of second standby cycles is zero from the second standby buffer 122. The number of second standby cycles being zero means that the second read time is included in the execution period of the second read cycle. Therefore, the head data set whose number of second standby cycles is zero is the read target data set.

The controller 111 generates a command data set based on the feedback data set read out by the second reading unit 123. If the control server 100 includes a plurality of controllers 111, the control server 100 may include a plurality of second arrangement units 121, a plurality of second standby buffers 122, and a plurality of second reading units 123. The plurality of second arrangement units 121 correspond to a plurality of controllers 111, the plurality of second standby buffers 122 correspond to a plurality of second arrangement units 121, and the plurality of second reading units 123 correspond to a plurality of second standby buffer 122. Each of the plurality of second arrangement units 121 reads the feedback data from the corresponding local controller 315 from the second reception buffer 222 based on the identification information of the local controller 315 added to the feedback data set, and transmits the feedback data to the corresponding second standby buffer 122. Accordingly, a plurality of feedback data sets acquired by the corresponding local controller 315 are stored for each of the plurality of second standby buffers 122.

The control server 100 may further include a second delay setting unit 131. The second delay setting unit 131 sets a second delay time for converting the second reference timing into the second read timing based on an input to the user interface.

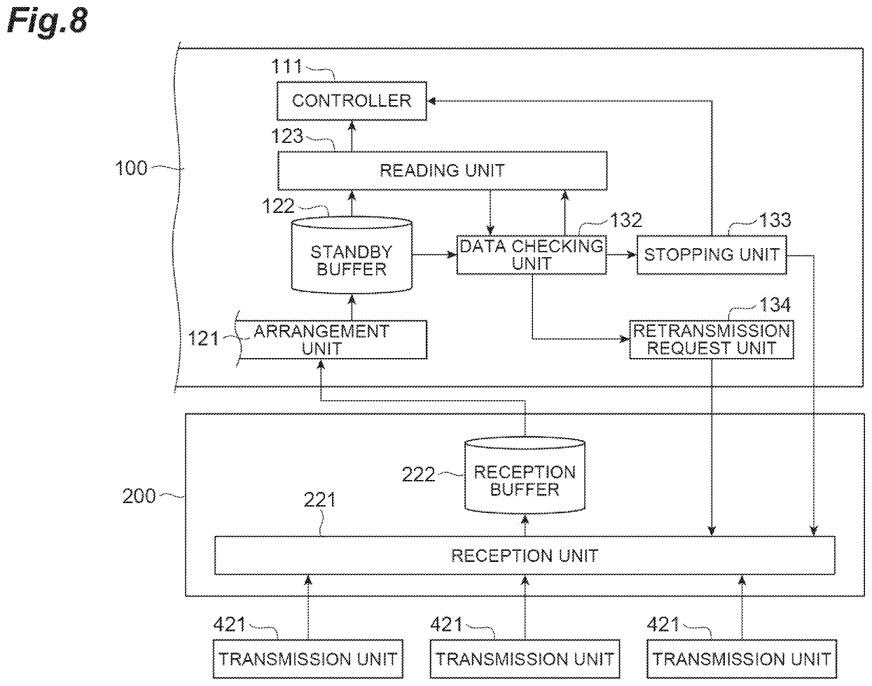

As illustrated in FIG. 8, the control server 100 may further include a second data checking unit 132, a second stopping unit 133, and a second retransmission request unit 134. If the control server 100 includes a plurality of controllers 111, the control server 100 may further include a plurality of sets of second data checking units 132, second stopping units 133, and second retransmission request units 134, each corresponding to the plurality of controllers 111. The second data checking unit 132 detects the missing of the feedback data set read in the second read cycle based on the arrangement of the plurality of feedback data sets in the second standby buffer 122 and the second timing information.

For example, when the second timing information of the head data set does not correspond to the second read cycle for reading the head data set, the second data checking unit 132 detects the missing of the feedback data set to be read before the head data set. For example, when the second read time of the head data set specified by the second timing information is not included in the executing period of the second read cycle for reading the head data set, the second data checking unit 132 detects the missing of the feedback data set to be read before the head data set.

Hereinafter, a read cycle in which the head data set is read is referred to as a “head read cycle”. The missing of the feedback data set to be read before the head data set is referred to as “missing of read target data set”. As described above, when the cycle length of the second read cycle matches the cycle length of the local control cycle, there is one read target data set for each second read cycle unless the feedback data set is missed. Therefore, each second read cycle becomes a “head read cycle”. The second data checking unit 132 may detect a missing of read target data set when the number of second standby cycles of the head data set is not zero.

The second data checking unit 132 may check whether the second timing information of the head data set corresponds to the head read cycle after the head read cycle is started or before the head read cycle is started.

The second reading unit 123 may wait to read the head data set until a second read cycle after the head read cycle when a missing of read target data is detected.

The second data checking unit 132 may detect, when the difference between the second read times is twice or more the second read cycle between the two feedback data sets adjacent to each other in the arrangement in the second standby buffer 122, the missing of the feedback data set to be arranged between the two feedback data sets. Hereinafter, the missing of the feedback data set to be disposed between two feedback data sets is referred to as an “absence of feedback data set”.

The second stopping unit 133 may cause the controller 111 to output a command to stop the drive unit (for example, the actuators 71, 72, 73, 74, 75, 76, the automated guided vehicle 31, the automated guided vehicle 33, and the like of the machine 30) when the number of second read cycles in which missing of the feedback data set is consecutively detected reaches a predetermined second number for drive stoppages. The communication between the second receiving unit 221 and the second transmission unit 421 may be stopped when the number of second read cycles in which the missing of the feedback data set is consecutively detected reaches a predetermined second number for communication stoppages, the predetermined second number for communication stoppages being greater than the second number for drive stoppages. For example, when the number of head read cycles in which the missing of read target data set is detected reaches the second number for drive stoppages, the second stopping unit 133 may cause the controller 111 to output a command to stop the drive unit. The second stopping unit 133 may stop communication between the second receiving unit 221 and the second transmission unit 421 when the number of head read cycles in which the missing of read target data set is consecutively detected reaches the second number for communication stoppages. The second stopping unit 133 may cause the controller 111 to output a stop command to the drive unit when the number of times of detection of absences of feedback data set between two feedback data sets reaches the second number for drive stoppages. The second stopping unit 133 may stop communication between the second receiving unit 221 and the second transmission unit 421 when the number of times of detection of absences of feedback data set between two feedback data sets reaches the second number for communication stoppages.

When the missing of the feedback data set is detected by the second data checking unit 132, the second retransmission request unit 134 requests the second transmission unit 421 to retransmit the feedback data set that is detected to be missing. For example, when the absence of feedback data set is detected by the second data checking unit 132, the second retransmission request unit 134 may request the second transmission unit 421 to retransmit the feedback data set that is absent. The second retransmission request unit 134 may request the second transmission unit 421 to retransmit the read target data set if missing of read target data set is detected.

The second retransmission request unit 134 may cause the second receiving unit 221 to request the second transmission unit 421 to retransmit the feedback data set. The second transmission unit 421 may be configured to hold the transmitted feedback data set in preparation for a request for retransmission from the second retransmission request unit 134. The second arrangement unit 121 may cause the second receiving unit 221 to transmit an acknowledge signal of the feedback data set to the second transmission unit 421 when the feedback data set is stored in the second standby buffer 122. The second transmission unit 421 may hold the feedback data set until an acknowledge signal is received.

Hardware Configuration

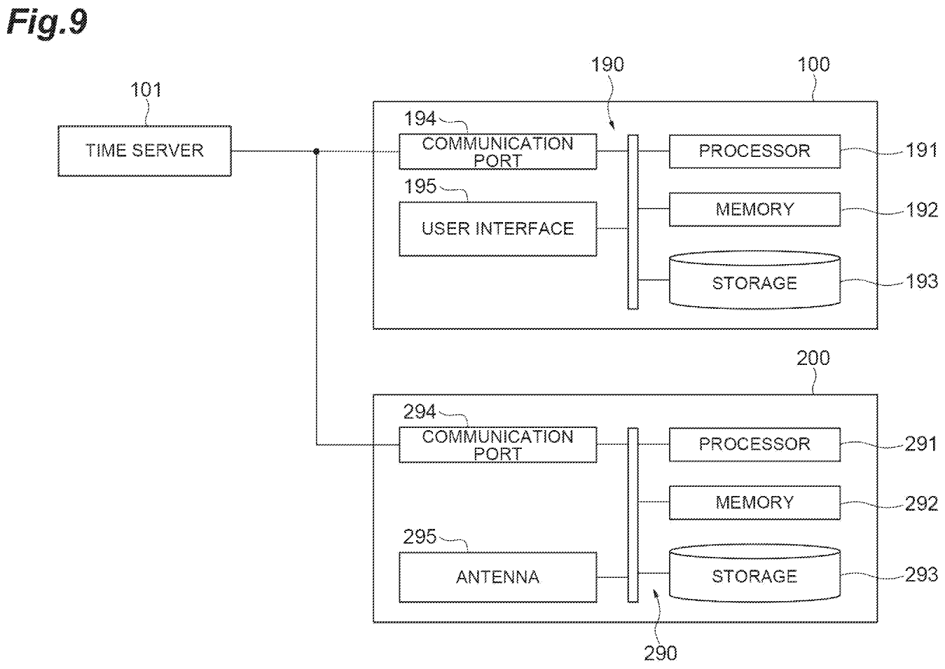

FIG. 9 is a block diagram illustrating hardware configurations of the control server 100 and the communication device 200. As illustrated in FIG. 9, the control server 100 includes circuitry 190. The circuitry 190 includes a processor 191, a memory 192, storage 193, a communication port 194, and a user interface 195.

The storage 193 is a nonvolatile storage medium. Examples of the storage 193 include a hard disk and a flash memory. The storage 193 may be a portable storage medium such as an optical disk. The storage 193 stores a program for causing the control server 100 to control the machine 30 and to add the order information to each of a plurality of command data sets to be sent to the communication device 200. For example, the storage 193 stores a program for causing the control server 100 to configure each functional block described above.

The memory 192 is a temporary storage medium such as a random-access memory, and temporarily stores the program loaded from the storage 193. The processor 191 is configured by one or more arithmetic elements, and causes the control server 100 to configure each functional block by executing a program loaded into the memory 192. The communication port 194 communicates with the time server 101 and the communication device 200 in response to requests from the processor 191.

The user interface 195 is an apparatus that receives input by a user and presents information to the user, and includes, for example, an input device and a display device. Examples of the input device include a keyboard, a mouse, and a keypad. Examples of the display device include a liquid crystal monitor or an organic electro-luminescence (EL) monitor. The input device may be integrated with the display device as a so-called touch panel.

The communication device 200 includes circuitry 290. The circuitry 290 has a processor 291, a memory 292, storage 293, and a communication port 294.

The storage 293 is a nonvolatile storage medium. Examples of the storage 293 include a hard disk and a flash memory. The storage 293 may be a portable storage medium such as an optical disk. The storage 293 stores a program for causing the communication device 200 to configure each functional block described above.

The memory 292 is a temporary storage medium such as a random-access memory, and temporarily stores the program loaded from the storage 293. The processor 291 is configured by one or more arithmetic elements, and causes the communication device 200 to configure each functional block by executing a program loaded into the memory 292. The communication port 294 communicates with the communication port 194 in response to requests from the processor 291. An antenna 295 transmits and receives a signal for wireless communication in response to requests from the processor 291.

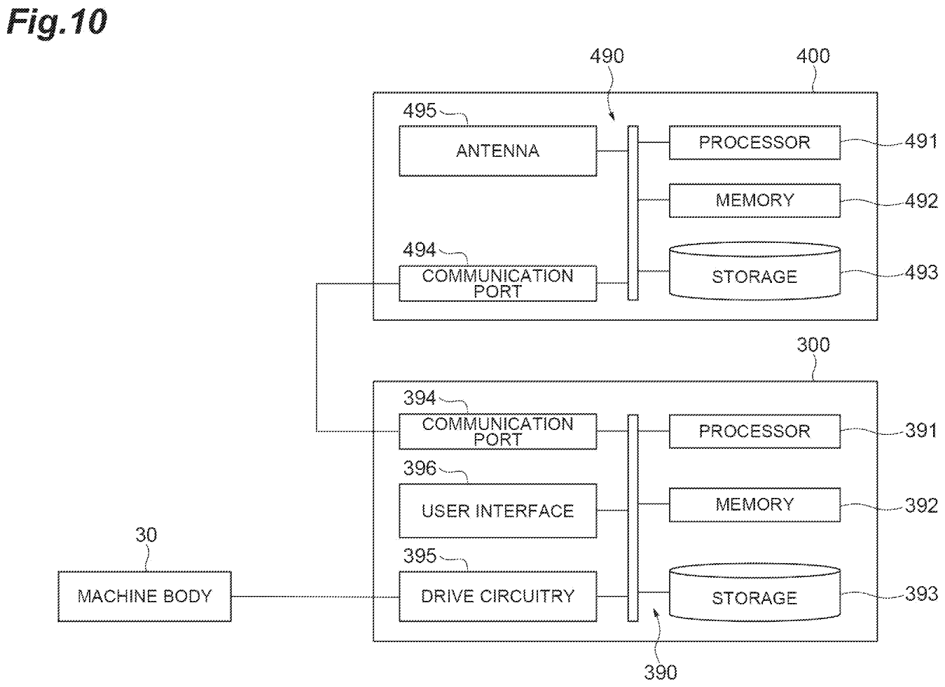

FIG. 10 is a block diagram illustrating hardware configurations of the local device 300 and the communication device 400. As illustrated in FIG. 10, the local device 300 includes circuitry 390. The circuitry 390 includes a processor 391, a memory 392, storage 393, a communication port 394, and drive circuitry 395.

The storage 393 is a nonvolatile storage medium. Examples of the storage 393 include a hard disk and a flash memory. The storage 393 may be a portable storage medium such as an optical disk. The storage 393 stores a program for causing the local device 300 to execute: arranging a plurality of command data sets acquired from the communication device 400 in a standby buffer in an order based on order information; sequentially reading the plurality of command data sets stored in the standby buffer in the order in which the plurality of command data sets are arranged; and operating the machine 30 based on the read command data sets. For example, the storage 393 stores a program for causing the local device 300 to cause the local device 300 to configure each functional block described above.

The memory 392 is a temporary storage medium such as a random-access memory, and temporarily stores the program loaded from the storage 393. The processor 391 is configured by one or more arithmetic elements, and causes the local device 300 to configure each functional block by executing a program loaded into the memory 392. The communication port 394 communicates with the communication device 400 in response to requests from the processor 391.

The drive circuitry 395 outputs drive power to the machine 30 and obtains feedback data set from the machine 30 in response to requests from the processor 391.

A user interface 396 is an apparatus that receives input by a user and presents information to the user, and includes, for example, an input device and a display device. Examples of the input device include a keyboard, a mouse, and a keypad. Examples of the display device include a liquid crystal monitor and an organic electro-luminescence (EL) monitor. The input device may be integrated with the display device as a so-called touch panel.

The communication device 400 includes circuitry 490. The circuitry 490 includes a processor 491, a memory 492, storage 493, and a communication port 494.

The storage 493 is a nonvolatile storage medium. Examples of the storage 493 include a hard disk and a flash memory. The storage 493 may be a portable storage medium such as an optical disk. The storage 493 stores a program for causing the communication device 400 to configure each functional block described above.

The memory 492 is a temporary storage medium such as a random-access memory, and temporarily stores the program loaded from the storage 493. The processor 491 is configured by one or more arithmetic elements, and causes the communication device 400 to configure each functional block by executing a program loaded into the memory 492. The communication port 494 communicates with the communication port 394 in response to requests from the processor 491. An antenna 495 transmits and receives a signal for wireless communication in response to requests from the processor 491.

The hardware configuration described above is merely an example and can be modified. For example, the communication system 1 may include a plurality of hardware devices each including a plurality of controllers 111. In the control server 100, the information addition unit 113, the second arrangement unit 121, the second standby buffer 122, the second reading unit 123, the second delay setting unit 131, the second data checking unit 132, the second stopping unit 133, and the second retransmission request unit 134 that form part of the communication system 1 may be incorporated into the communication device 200. In the local device 300, the arrangement unit 312, the standby buffer 313, the reading unit 314, the delay setting unit 321, the data checking unit 322, the stopping unit 323, the retransmission request unit 324, and the second information addition unit 331 that form part of the communication system 1 may be incorporated into the communication device 400. The communication device 200 may be incorporated into the control server 100 and the communication device 400 may be incorporated into the local device 300.

Communication Procedure

Next, as an example of the communication method, an example control procedure including a communication procedure executed by the communication system 1 will be described. This control procedure includes: sequentially generating a plurality of command data sets; adding order information to each of the command data sets; sequentially transmitting the plurality of command data sets to which the order information is added; sequentially receiving the transmitted command data sets; arranging the received command data sets in the standby buffer 313 in an order based on the order information; and sequentially reading the plurality of command data sets stored in the standby buffer 313 in the order in which the plurality of command data sets are stored.

Hereinafter, the example control procedure will be described by dividing it into a generation and transmission procedure of a command data set executed by the control server 100, an arrangement procedure of a plurality of feedback data sets executed by the control server 100, a communication procedure executed by the communication device 200, a local control procedure executed by the local device 300, an arrangement procedure of a plurality of command data sets executed by the local device 300, and a communication procedure executed by the communication device 400.

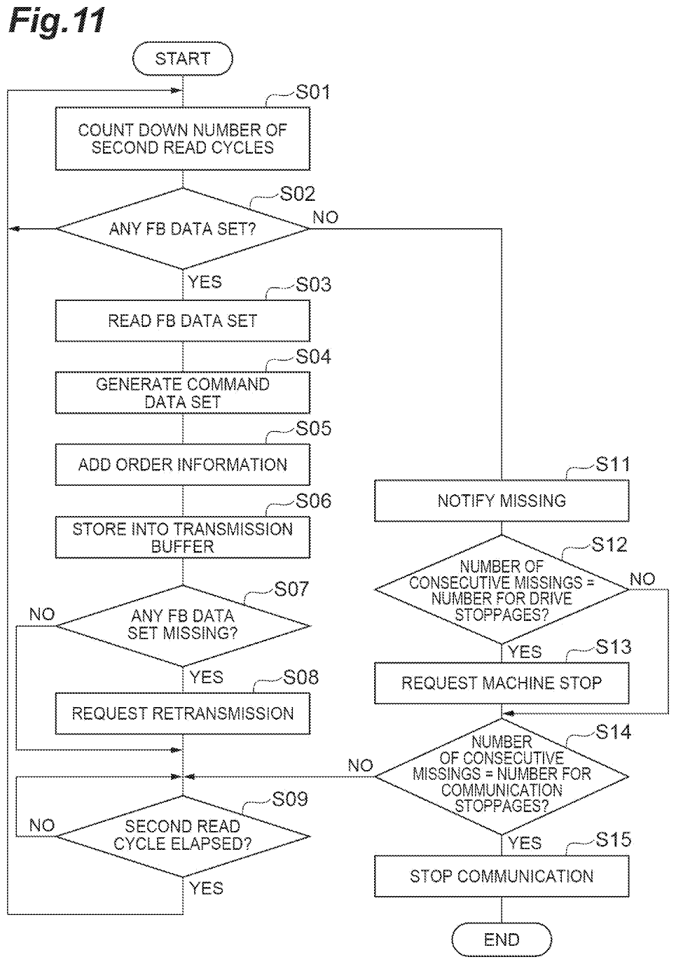

Command Data Set Generation and Transmission Procedure FIG. 11 is a flowchart illustrating a procedure for generating and transmitting the command data set. The flowchart of FIG. 11 is executed in a state where a plurality of feedback data sets are stored in the second standby buffer 122 in an order based on the second order information. The second order information of each of the plurality of feedback data sets includes second timing information converted into the number of second read cycles from the time of storage in the second standby buffer 122 to the second read time.

As illustrated in FIG. 11, the control server 100 first executes operations S01 and S02. In the operation S01, the second reading unit 123 counts down the number of second read cycles by one in each of the plurality of feedback data sets in the second standby buffer 122. In the operation S02, the second reading unit 123 checks whether there is a read target data set in the second standby buffer 122. For example, the second reading unit 123 checks whether the number of second read cycles of the head data set in the second standby buffer 122 is zero.

If it is determined in the operation S02 that there is a read target data set, the control server 100 executes operations S03, S04, S05, and S06. In the operation S03, the second reading unit 123 reads the head data set (feedback data set) from the second standby buffer 122. In the operation S04, the controller 111 generates a command data set based on the head data set read by the second standby buffer 122. In the operation S05, the information addition unit 113 adds order information to the command data set generated by the controller 111. In the operation S06, the information addition unit 113 stores a command data set to which the order information is added in the transmission buffer 212.

Next, the control server 100 executes a operation S07. In the operation S07, the second data checking unit 132 checks whether there is an absence of feedback data set in the second standby buffer 122. If it is determined in the operation S07 that there is an absence of feedback data set, the control server 100 executes a operation S08. In the operation S08, the second retransmission request unit 134 requests the second transmission unit 421 to retransmit the feedback data set that is detected to be absent.

Next, the control server 100 executes a operation S09. If it is determined in the operation S07 that there is no absence of feedback data set in the operation S07, the control server 100 executes the operation S09 without executing the operation S08. In the operation S09, the second reading unit 123 waits for the second read cycle to elapse. The control server 100 then returns the processing to the operation S01.

If it is determined in the operation S02 that there is no read target data set, the control server 100 executes operations S11 and S12. In the operation S11, the second data checking unit 132 detects the missing of read target data set and notifies the occurrence of the missing. For example, the second data checking unit 132 notifies the occurrence of the missing by displaying it on a display device of the user interface 195. In the operation S12, the second stopping unit 133 checks whether the number of head read cycles whose read target data were detected to be consecutively missing is the second number for drive stoppages. Hereinafter, the number of head read cycles whose read target data were detected to be consecutively missing is referred to as a “number of consecutive missings”.

If it is determined in the operation S12 that the number of consecutive missings is the second number for drive stoppages, the control server 100 executes a operation S13. In the operation S13, the second stopping unit 133 causes the controller 111 to output a command to stop the operation of the machine 30.

Next, the control server 100 executes a operation S14. If it is determined in the operation S12 that the number of consecutive missings is not the second number for drive stoppages, the control server 100 executes the operation S14 without executing the operation S13. In the operation S14, the second stopping unit 133 checks whether the number of consecutive missings is the second number for communication stoppages. If it is determined in the operation S14 that the number of consecutive missings is not the second number for communication stoppages, the control server 100 advances the processing to the operation S09. Thereafter, after the elapse of the read cycle is waited, the processing is returned to the operation S01. Accordingly, the reading of the head data set is waited until the next read cycle.

If it is determined in the operation S14 that the number of consecutive missings is the second number for communication stoppages, the control server 100 executes a operation S15. In the operation S15, the second stopping unit 133 stops communication between the second receiving unit 221 and the second transmission unit 421. Thus, the procedure for generating and transmitting the command data set is completed.

Arrangement Procedure of Plurality of Command Data Sets

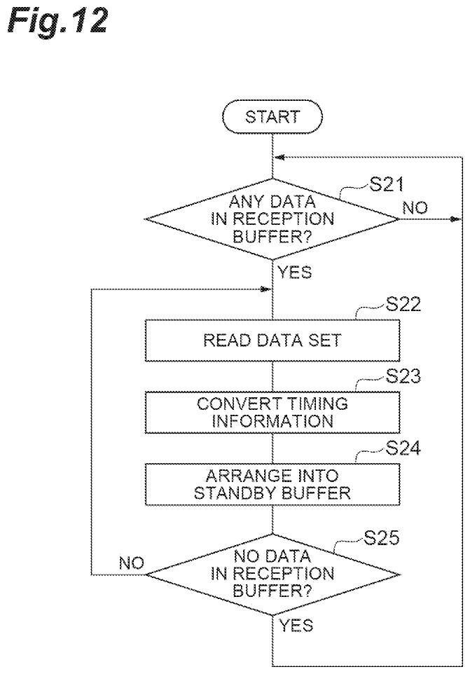

As illustrated in FIG. 12, the local device 300 executes operations S21, S22, S23, S24, and S25. In the operation S21, the arrangement unit 312 waits for one or more command data sets to be stored in the reception buffer 412. In the operation S22, the arrangement unit 312 reads the command data from the reception buffer 412 in the order in which they were stored. In the operation S23, the arrangement unit 312 converts the timing information of the read command data set into the number of read cycles from the time of storage in the standby buffer 313 to the read time. In the operation S24, the arrangement unit 312 arranges the command data set, which is obtained by converting the timing information into the number of read cycles, in the standby buffer 313 in the order of the read timing defined by the timing information (in ascending order of the number of read cycles).

In the operation S25, the arrangement unit 312 checks whether the command data set that has not been read remains in the reception buffer 412. If it is determined in the operation S25 that an unread command data set remains in the reception buffer 412, the local device 300 returns the processing to the operation S22. Thereafter, the reading of the command data set and the arrangement into the reception buffer 412 are repeated until the reading of the command data set from the standby buffer 313 is completed. If it is determined in the operation S25 that no unread command data set remains in the reception buffer 412, the local device 300 returns the processing to the operation S21. The local device 300 repeatedly executes the above processing.

Communication Procedure

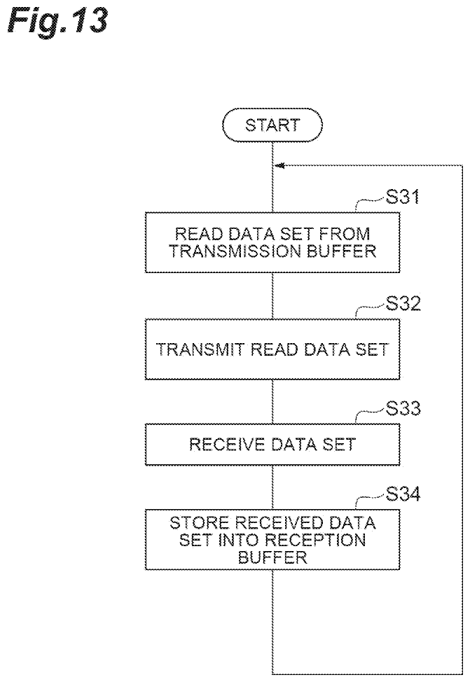

As illustrated in FIG. 13, the communication device 200 repeatedly executes operations S31, S32, S33, and S34. In the operation S31, the transmission unit 211 reads the command data from the transmission buffer 212 in the order in which they were stored. In the operation S32, the transmission unit 211 transmits the read command data set to the reception unit 411. In the operation S33, the second receiving unit 221 receives the feedback data set transmitted from the second transmission unit 421. In the operation S34, the second receiving unit 221 stores the received feedback data set in the second transmission buffer 422.

Local Control Procedure

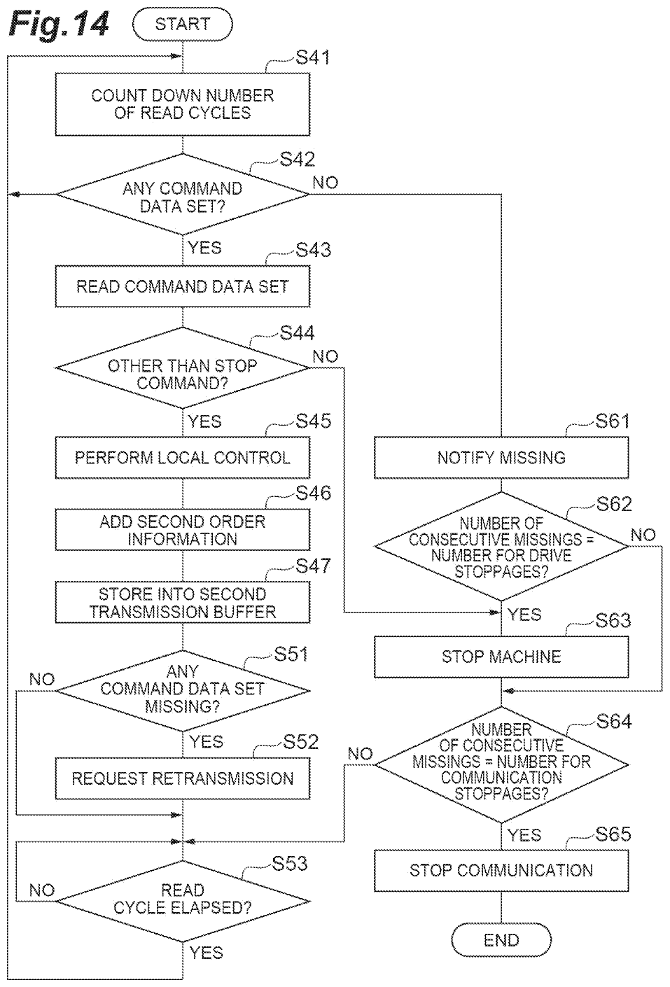

FIG. 14 is a flowchart illustrating a local control procedure. The flowchart of FIG. 14 is executed in a state where a plurality of command data sets are stored in the standby buffer 313 in an order based on the order information. The order information of each of the plurality of command data sets includes timing information converted into the number of read cycles from the time of storage in the standby buffer 313 to the read time.

As illustrated in FIG. 14, the local device 300 first executes operations S41 and S42. In the operation S41, the reading unit 314 counts down the number of read cycles by one in each of the plurality of command data sets in the standby buffer 313. In the operation S42, the reading unit 314 checks whether there is a read target data set in the standby buffer 313. For example, the reading unit 314 checks whether the read cycle number of the head data sets in the standby buffer 313 is zero.

If it is determined in the operation S42 that there is a read target data set, the local device 300 executes operations S43 and S44. In the operation S43, the reading unit 314 reads the head data set (command data set) from the standby buffer 313. In the operation S44, the local controller 315 checks whether the command data set read from the standby buffer 313 is a stop command.

In the operation S44, if it is determined that the command data set is not a stop command, the local device 300 executes operations S45, S46, and S47. In the operation S45, the local controller 315 operates the machine 30 based on the command data set read by the reading unit 314 and acquire a feedback data set representing the operation result of the machine 30. In the operation S46, the second information addition unit 331 adds second order information to the feedback data set acquired by the local controller 315. In the operation S47, the second information addition unit 331 stores feedback data set to which the second order information is added in the second transmission buffer 422.

Next, the local device 300 executes a operation S51. In the operation S51, the data checking unit 322 checks whether there is an absence of command data set in the standby buffer 313. If it is determined in the operation S51 that there is an absence of command data set, the local device 300 executes a operation S52. In the operation S52, the retransmission request unit 324 requests the transmission unit 211 to retransmit the command data set that is detected to be absent.

Next, the local device 300 executes a operation S53. When it is determined that there is no absence of command data set in the operation S51, the local device 300 executes the operation S53 without executing the operation S52. In the operation S53, the second reading unit 123 waits for the read cycle to elapse. The control server 100 then returns the processing to the operation S41.

If it is determined in the operation S42 that there is no read target data set, the local device 300 executes operations S61 and S62. In the operation S61, the data checking unit 322 detects the missing of read target data set and notifies the occurrence of the missing. For example, the data checking unit 322 notifies the occurrence of the missing by displaying it on a display device of the user interface 396. In the operation S62, the stopping unit 323 checks whether the number of head read cycles whose read target data were detected to be consecutively missing is the number for drive stoppages. Hereinafter, the number of head read cycles whose read target data were detected to be consecutively missing is referred to as a “number of consecutive missing s”.

If it is determined in the operation S62 that the number of consecutive missings is the number for drive stoppages, the local device 300 executes a operation S63. If it is determined in the operation S44 that the command data set is a stop command, the local device 300 also executes the operation S63. In the operation S63, the stopping unit 323 causes the local controller 315 to stop the machine 30 from operating.

Next, the local device 300 executes a operation S64. If it is determined in the operation S62 that the number of consecutive missings is not number for drive stoppages, the local device 300 executes the operation S64 without executing the operation S63. In the operation S64, the stopping unit 323 checks whether the number of consecutive missings is the number for communication stoppages. If it is determined in the operation S64 that the number of consecutive missings is not a number for communication stoppages, the local device 300 advances the processing to the operation S53. Thereafter, after the elapse of the read cycle is waited, the processing is returned to the operation S41. Accordingly, the reading of the head data set is waited until the next read cycle.

If it is determined in the operation S64 that the number of consecutive missing is the number for communication stoppages, the local device 300 executes a operation S65. In the operation S65, the stopping unit 323 stops communication between the transmission unit 211 and the reception unit 411. Thus, the local control procedure is completed.

Arrangement Procedure for Plurality of Feedback Data Sets

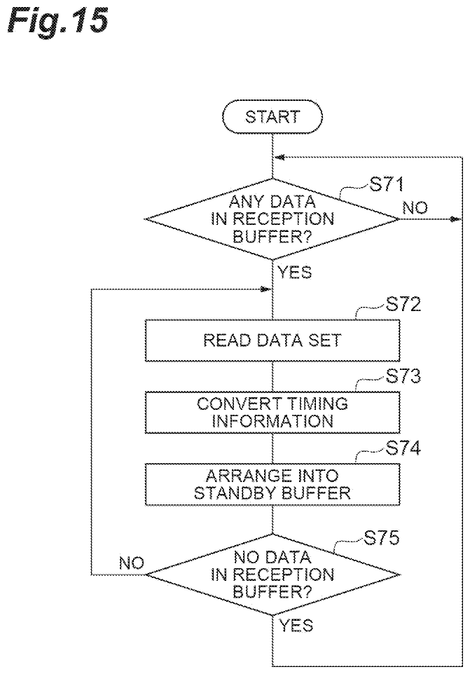

As illustrated in FIG. 15, the control server 100 executes operations S71, S72, S73, S74, and S75. In the operation S71, the second arrangement unit 121 waits for one or more feedback data sets to be stored in the second reception buffer 222. In the operation S72, the second arrangement unit 121 reads the feedback data set from the second reception buffer 222 in the order in which they were stored. In the operation S73, the second arrangement unit 121 converts the timing information of the read feedback data set into the number of second read cycles from the storage time in the second standby buffer 122 to the second read time. In the operation S74, the second arrangement unit 121 arranges the feedback data set, which is obtained by converting the timing information into the number of second read cycles, in the second standby buffer 122 in the order of the second read timing defined by the timing information (in ascending order of the number of second read cycles).

In the operation S75, the second arrangement unit 121 checks whether the feedback data set that has not been read remains in the second reception buffer 222. If it is determined in the operation S75 that an unread feedback data set remains in the second reception buffer 222, the control server 100 returns the process to the operation S72. Thereafter, the reading of the feedback data set and the arrangement into the second reception buffer 222 are repeated until the reading of the feedback data set from the second standby buffer 122 is completed. If it is determined in the operation S75 that there are no unread feedback data sets left in the second reception buffer 222, the control server 100 returns the processing to the operation S71. The control server 100 repeatedly executes the above processing.

Communication Procedure

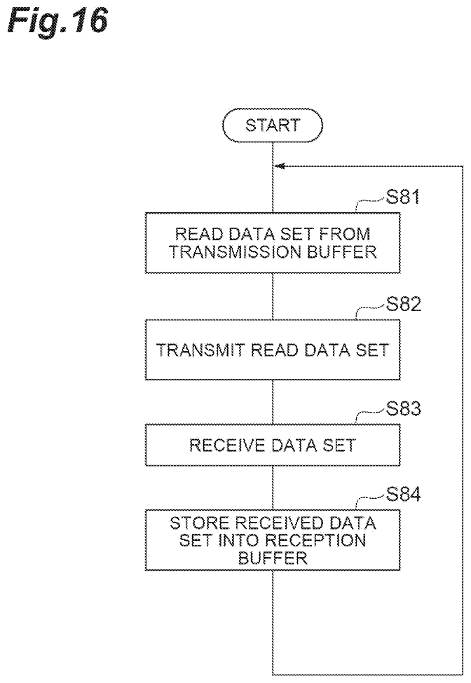

As illustrated in FIG. 16, the communication device 400 repeatedly executes operations S81, S82, S83, and S84. In the operation S81, the second transmission unit 421 reads the feedback data set from the second transmission buffer 422 in the order in which they were stored. In the operation S82, the second transmission unit 421 transmits the read feedback data set to the second receiving unit 221. In the operation S83, the reception unit 411 receives the command data set transmitted from the transmission unit 211. In the operation S84, the reception unit 411 stores the received command data set in the reception buffer 412.

### SUMMARY

As described above, the communication system 1 includes: the information addition unit 113 configured to add order information to each of a plurality of data sets; the transmission unit 211 configured to sequentially transmit a plurality of data sets to which the order information is added; the reception unit 411 configured to sequentially receive the plurality of data sets from the transmission unit 211; the arrangement unit 312 configured to arrange the plurality of data sets received by the reception unit 411 in the standby buffer 313 in an order based on the order information; and the reading unit 314 configured to sequentially read the plurality of data sets stored in the standby buffer 313 in the order in which the plurality of data sets are arranged.

In communication, the transmission order of a plurality of data sets and the reception order of a plurality of data sets may be changed. For example, a data set that was transmitted earlier may be received later than a data set that was transmitted later. Even if the transmission order and the reception order are changed, with this the communication system 1, a plurality of data sets can be sequentially read in an order based on the order information. Therefore, the order of use of a plurality of data sets can be controlled by the order information regardless of reception order. Accordingly, a plurality of data sets received by communication may be used in an expected order.

The order information may include timing information that defines read timing and the reading unit 314 may be configured to read each of the plurality of data sets at read timing specified by the timing information. The read timing can be controlled based on the timing information.

The arrangement unit 312 may be configured to arrange the plurality of data sets in the standby buffer 313 in the order of read timing based on the timing information included in the order information. Since both the arrangement by the arrangement unit 312 and the read timing by the reading unit 314 are controlled by the timing information, the information added to the data set can be reduced.

The timing information may be information indicating reference timing before transmission timing by the transmission unit 211 and the reading unit 314 may be configured to read each of the plurality of data sets at read timing at which a predetermined delay time has elapsed from the reference timing. The read timing can readily be adjusted by adjusting the delay time.

The system may further include the delay setting unit 321 configured to set the delay time based on an input to the user interface. The read timing can readily be changed in accordance with the application of the communication system 1.

The reading unit 314 may be configured to repeat reading the data set from the standby buffer 313 at a constant read cycle and the communication system 1 may further include the data checking unit 322 configured to detect missing of a data set read in the read cycle based on the arrangement of the plurality of data sets in the standby buffer 313 and the timing information. Missing of the data set can readily be detected based on the relationship between the read cycle and the timing information.

The plurality of data sets may include a data set used for controlling a drive unit (for example, the actuators 71, 72, 73, 74, 75, 76 of the machine 30, the automated guided vehicle 31, the automated guided vehicle 33, and the like) and the communication system 1 may further include the stopping unit 323 configured to stop the drive unit when the number of read cycles in which the missing of the data set is consecutively detected reaches a predetermined number for drive stoppages. Unexpected operation of the drive unit caused by unstable communication can be avoided.

The stopping unit 323 may be configured to stop communication between the transmission unit and the reception unit when the number of read cycles in which missing of the data set is consecutively detected reaches a predetermined number for communication stoppages, the predetermined number for communication stoppages being greater than the number for drive stoppages. Excessive continuation of unstable communication may be avoided while maintaining communication even after the drive unit is stopped.

The data checking unit 322 may be configured to detect, when the timing information of a head data set located at a head of the arrangement in the standby buffer 313 does not correspond to the read cycle for reading the head data set, missing of a data set to be read before the head data set. Missing of data set can more readily be detected.

The reading unit 314 may be configured to, when missing of a data set to be read before the head data set is detected, wait for reading of the head data set until a read cycle next to a read cycle in which the head data set is to be read. An arrangement based on the order information can be used to readily cope with missing of data sets.

The system may further include the retransmission request unit 324 configured to request the transmission unit 211 to retransmit the data set when the missing of the data set is detected by the data checking unit 322. Missing of the data set can be prevented.

The transmission unit 211 may be configured to hold the data set that has been transmitted in preparation for a retransmission request from the retransmission request unit 324. Missing of data set may further be prevented.

The reception unit 411 may be configured to store the plurality of data sets in the reception buffer 412 in an order in which the plurality of data sets are received and the arrangement unit 312 may be configured to: read the plurality of data sets stored in the reception buffer 412 from the reception buffer 412 in the order in which the plurality of data sets are stored; and arrange the plurality of data sets in the standby buffer 313 in an order based on the order information. The configuration of the reception buffer 412 can be simplified on the premise that the order of arrangement is arranged by the arrangement unit 312.

The transmission unit 211 may be configured to transmit the data set via network communication and the reception unit 411 may be configured to receive a data set from the transmission unit 211 via the network communication. In the network communication, the order is prone to be changed. Accordingly, it is more beneficial to control the use order of a plurality of data sets by order information regardless of reception order.

The transmission unit 211 may be configured to transmit the data set via wireless communication and the reception unit 411 may be configured to receive a data set from the transmission unit 211 via the wireless communication. It is more beneficial to control the use order of a plurality of data sets by order information regardless of reception order.

The transmission unit 211 may be configured to transmit a data set via mobile communication and the reception unit 411 may be configured to receive a data set from the transmission unit 211 via the mobile communication. In to mobile communication, the order is prone to be changed. Accordingly, it is more beneficial to control the use order of a plurality of data sets by order information regardless of reception order.

The control system 10 includes: the communication system 1 as described above; the controller 111 configured to sequentially generate a plurality of command data sets; and the local controller 315 configured to operate a machine based on the plurality of command data sets. The information addition unit 113 is configured to add order information to each of the plurality of command data sets generated by the controller 111. The transmission unit 211 is configured to sequentially transmit the plurality of command data sets to which the order information is added. The reception unit 411 is configured to sequentially receive the plurality of command data sets. The arrangement unit 312 is configured to arrange the plurality of command data sets received by the reception unit 411 in the standby buffer 313 in an order based on the order information. The reading unit 314 is configured to sequentially read the plurality of command data sets stored in the standby buffer 313 in the order in which the plurality of command data sets are arranged. The local controller 315 is configured to operate the machine based on the plurality of command data sets read by the reading unit 314. The communication system 1 can be utilized for synchronous communication in machine control.

The local controller 315 may be configured to sequentially acquire a plurality of feedback data sets including an operation result based on the plurality of command data sets. The communication system 1 may further include: the second information addition unit 331 configured to add second order information to each of the plurality of feedback data sets acquired by the local controller 315; the second transmission unit 421 configured to sequentially transmits the plurality of feedback data sets to which second order information is added; the second receiving unit 221 configured to sequentially receive the plurality of feedback data sets from the second transmission unit 421; the second arrangement unit 121 configured to arrange the plurality of feedback data sets received by the second receiving unit 221 in the second standby buffer 122 in an order based on the second order information; and the second reading unit 123 configured to sequentially read the plurality of feedback data sets stored in the second standby buffer 122 in the order in which the plurality of feedback data sets are arranged. The communication system 1 can further be utilized for machine control.

The controller 111 may be configured to generate the command data set based on the feedback data set read by the second reading unit 123. The communication system 1 can further be utilized for construction of a feedback loop in machine control.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A communication system comprising:
a first communication device configured to:
add order information to each of the plurality of data sets; and
sequentially transmit the plurality of data sets to which the order information is added; and
a second communication device configured to:
receive the plurality of data sets from the first communication device;
arrange the plurality of received data sets in a standby buffer as ordered data sets based on the order information; and
sequentially read the ordered data sets.

2. The communication system according to claim 1, wherein the order information includes timing information that defines read timing, and
wherein the second communication device is configured to read each of the plurality of data sets at the read timing specified by the timing information.

3. The communication system according to claim 2, wherein the second communication device is configured to arrange the plurality of data sets in the standby buffer in an order of the read timing based on the timing information included in the order information.

4. The communication system according to claim 2, wherein the first communication device is configured to repeat a transmit cycle to sequentially transmit the data sets;
wherein the timing information defines the read timing by indicating a reference timing that is predetermined in the transmit cycle, and
wherein the second communication device is configured to read each of the plurality of data sets at the read timing at which a predetermined delay time has elapsed from the reference timing.

5. The communication system according to claim 4, wherein the second communication device is further configured to set the delay time based on an input to a user interface.

6. The communication system according to claim 2, wherein the second communication device is configured to:
repeat a read cycle to sequentially read the ordered data sets from the standby buffer; and
detect a missing data set based on a comparison between an execution timing of the read cycle and the read timing of a data set corresponding to the read cycle in the ordered data sets.

7. The communication system according to claim 6, wherein a machine is controlled based on the ordered data sets sequentially read by the second communication device; and
wherein the second communication device is further configured to stop the machine in response to determining that a number of consecutive read cycles in each of which the missing data set is detected reaches a predetermined number for drive stoppages.

8. The communication system according to claim 7, wherein the second communication device is further configured to stop communication between the first communication device and the second communication device in response to determining that the number of consecutive read cycles reaches a predetermined number for communication stoppages, the number for communication stoppages being greater than the number for drive stoppages.

9. The communication system according to claim 6, wherein the second communication device is configured to detect the missing data set in response to determining that the read timing of a head data set located at a head of an arrangement in the standby buffer does not correspond to the execution timing of the read cycle.

10. The communication system according to claim 9, wherein the second communication device is configured to, in response to detecting the missing data set, wait for reading of the head data set until a read cycle next to the read cycle.

11. The communication system according to claim 6, wherein the second communication device is further configured to request the first communication device to retransmit the data set in response to detecting the missing data set.

12. The communication system according to claim 11, wherein the first communication device is configured to hold the data set that has been transmitted in preparation for a retransmission request from the second communication device.

13. The communication system according to claim 1, wherein the second communication device is configured to:
store the plurality of received data sets in a reception buffer in an order in which the plurality of data sets are received;
read the plurality of stored data sets from the reception buffer in the order in which the plurality of data sets are stored; and
arrange the plurality of read data sets in the standby buffer in an order based on the order information.

14. The communication system according to claim 1, wherein the first communication device is configured to transmit the plurality of data sets via network communication, and
wherein the second communication device is configured to receive the plurality of data sets from the first communication device via the network communication.

15. The communication system according to claim 14, wherein the first communication device is configured to transmit the plurality of data sets via wireless communication, and
wherein the second communication device is configured to receive the plurality of data sets from the first communication device via the wireless communication.

16. The communication system according to claim 15, wherein the first communication device is configured to transmit the plurality of data sets via mobile communication, and
wherein the second communication device is configured to receive the plurality of data sets from the first communication device via the mobile communication.

17. A control system comprising:
the communication system according to claim 1;
a controller configured to sequentially generate a plurality of command data sets; and
a local controller configured to operate a machine based on the plurality of command data sets,
wherein the first communication device is configured to:
add the order information to each of a plurality of command data sets; and
sequentially transmit the plurality of command data sets to which the order information is added,
wherein the second communication device is configured to:
sequentially receive the plurality of command data sets;
arrange the plurality of received command data sets in the standby buffer as the ordered data sets based on the order information; and
sequentially read the ordered data sets, and
wherein the local controller is configured to operate the machine based on the ordered data sets sequentially read by the second communication device.

18. The control system according to claim 17, wherein the local controller is configured to sequentially acquire a plurality of feedback data sets including an operation result based on the plurality of command data sets, and
the second communication device is further configured to:
add second order information to each of the plurality of feedback data sets acquired by the local controller;
sequentially transmit the plurality of feedback data sets to which the second order information is added, and
wherein the first communication device is further configured to:
sequentially receive the plurality of feedback data sets from the second communication device;
arrange the plurality of received feedback data sets in a second standby buffer as a second ordered data sets based on the second order information; and
sequentially read the second ordered data sets.

19. The control system of claim 18, wherein the controller is configured to sequentially generate the command data sets based on the second ordered data sets sequentially read by the second ordered data sets.

20. A communication method comprising:
adding order information to each of a plurality of data sets;
sequentially transmitting the plurality of data sets to which the order information is added;
sequentially receiving the plurality of data sets;
arranging the plurality of received data sets in a standby buffer in an order based on the order information; and
sequentially reading the plurality of data sets stored in the standby buffer in the order in which the plurality of data sets are arranged.
